(19) United States
(12) Patent Application Publication
(10) Pub. No.: US 2015/0264024 A1
(43) Pub. Date: Sep. 17, 2015

(54) SYSTEM AND METHOD FOR CONFIDENTIAL REMOTE COMPUTING

(71) Applicant: Alexander Frank, Bellevue, WA (US)

(72) Inventor: Alexander Frank, Bellevue, WA (US)

(21) Appl. No.: 14/214,936

(22) Filed: Mar. 15, 2014

(51) Int. Cl. H04L 29/06

(52) U.S. Cl. CPC H04L 63/08

(57) ABSTRACT

A system, method, device and protocols are disclosed. Each and combined they protect computation and data hosted on remote computing resources from first party attacks.

First party attacks refer to attacks that are launched by agents (employees, contractors, etc.) of the hosting facility. Such attacks can be launched by the first patty agents, or some other adversary exploiting the privileges of the first party agent.

This invention allows customers to submit workloads to a remote computing facility, e.g. a datacenter or cloud computing, with the assurance that the administrators of the remote computers cannot access the workload computation and data.

The invention scales effectively from a single compute-server device to a whole datacenter with numerous compute-servers. It interoperates and may utilize VMM and VM deployment architectures. The invention allows varying degrees of datacenter operations access to the workload ranging from virtually none in the most strict case, to limited access to enable monitoring and maintenance of the workload.

This invention can be applied to existing cloud computing and other datacenters with off the self computing components. Further it can be applied to existing computing resource commonly in use in such facilities. Further, the invention is applicable to a wide variety of settings including single computers, computer labs, datacenters and public and private cloud computing services.

### CROSS-REFERENCE(S) TO RELATED APPLICATION(S)

This application claims the benefit of the filing date of the U.S. Provisional Patent Application 61/801,920 entitled “SYSTEM AND METHOD FOR CONFIDENTIAL REMOTE COMPUTING”, filed on 15 Mar. 2013, the disclosure of which is hereby expressly incorporated by reference in its entirety and the filing date of which is hereby claimed under 35 USC §119(e).

### TECHNICAL FIELD

This application relates generally to the field of secure computing. More specifically, it addresses the question of how to enable confidential computing in remote locations, on computers owned or administered by another party. An application of the invention enables confidential cloud computing, such that the operators of the cloud facility won't have unauthorized access to the computation and its results. The invention has similar applications and benefits in other settings, like private cloud, corporate datacenters and offloading computing to other premises.

### BRIEF DESCRIPTION OF THE DRAWINGS

The drawings, when considered in connection with the following description, are presented for the purpose of facilitating an understanding of the subject matter sought to be protected.

FIGS. 1A and 1B show example network configurations where the invention can be used;

FIGS. 2A, 2B and 2C show example configurations of the invention;

FIGS. 3A and 3B show example block diagrams of a compute-server in FIG. 1;

FIG. 4 shows an example block diagram of an Isolated Computing Environment (ICE);

FIG. 5 shows a flowchart of an example compute-server boot sequence and vetting (from the compute-server perspective);

FIGS. 6A and 6B illustrate a two and three staged boot sequence and vetting of the compute-server side;

FIG. 7 shows an example of the vetting process scaled to enable trustworthy virtual computing.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references datacenter computing resources, it will be appreciated that the disclosure may be used with other types of computing resources such as cloud computing, offloading workloads to remote facilities, and storage hosted remotely in various facilities like cloud computing and datacenters.

Problem Statement:

Consider the simple case of a personal computer at home. Even though the Operating System (OS) running on said computer can often manage multiple user accounts, the owner or administrator of the computer can ultimately access data and computations of other users. Once obtaining access, the administrator could divulge or alter the data and computation of other users. There may be security facilities isolating the computations and data of other users, but an administrator of the computer can disable said security mechanisms or circumvent them. This can be done when installing the OS, later by installing a custom patch or software that can access the data and computations of other users, or by configuring the computer and its OS to allow the administrator access to other user data and computation.

This problem exists also in datacenters and cloud computing facilities, albeit in larger scale and more failure modes. That is, as datacenters and cloud computing facilities are more complex than a single computer at home there may be more ways for the administrators of the datacenter to exploit their access rights to access confidential data and computation.

The invention refers to this family of threats as “first party threats” because the threats and related attacks are originated from insiders, agents of the first party, the party which provides the datacenter facility and its services.

The word “datacenter” is used herein loosely to describe any collection of computing resources that may serve other parties. This includes both computation and storage as well as other services that may be rendered by such computing resources. Examples of datacenters range from large warehouses hosting public and private cloud computing—at the upper scale, through hosted computing facilities, through computation centers operated or at least controlled by corporations and other organizations (e.g. universities, government agencies), to smaller scale computer rooms used by departments, company branches or small businesses. (At the smallest extreme one may refer to a home based computer as a datacenter—albeit, some may consider this as an academic stretch of the term).

Cloud computing facilities are a special case of datacenter. Like datacenters they host data and computation of various users, customers of the datacenter, who depend on the datacenter staff to manage it and maintain its security. In fact, cloud computing may host the effectively virtual datacenter (or portion thereof) of corporations or other organizations. Said customers may be located remotely, and usually they have limited access to the datacenter itself and its resources. Often the customer access to the datacenter resources is highly structured as so to enable access only the customer data and computation itself, possibly excluding even telemetry related to the hosting of the customer data and computations.

However, unlike many datacenters—e.g. those of corporations, the customers and the cloud provider are separate entities with everything it entails. For instance, when a corporate datacenter has a breach, it is primarily the first party—the corporate—which sustains the damage. However, in the cloud it is the customer, a second or third party, which is damaged by security breaches.

As can be appreciated by skilled in the art, these problems are inherent to large datacenters, because the operating staff is large, and many of its members have effectively administration privileges sufficient to access confidential data and computation. Further, due to the size and complexity of these datacenters, their staff may include contractors and subcontractors from diverse geographies and different legal frameworks. Furthermore, the group of people who may have admin privileges to access the datacenter resources or a portion thereof might not be well defined, due to the multiple levels of subcontracting and abstraction of the various roles to allow flexible operation satisfying demanding SLAs and high availability requirements. Consequently, it is plausible that effectively-unknown agents may obtain unauthorized access to confidential data and computation, just by virtue of belonging to the extended datacenter staff.

The “first party threat” is amplified by the possibility of unintentional alleviation of privilege. Observe that the larger and more complex a datacenter is, the larger and less-well defined the actual group of its administrators often is. Each of the individuals or entities with some sort of admin privileges is a potential target for an alleviation of privilege attack. The simplest form of such attack is for the credentials of an administrator to be divulged or breached somehow. Then an attacker can logon-to the datacenter end exploit these privileges. Other more sophisticated forms of alleviation of privilege involved a software attack, which results in the attacker code being executed with administrator privileges (without knowing her credentials). The larger and more convoluted the admin group is, the more opportunity for such events to transpire.

This invention addresses these inherent issues. Therefore, it is called Confidential Remote Computing. It is applicable in many remote computing situations, including cloud computing and corporate datacenters.

### DESCRIPTION

### Overview

The description starts with a user who needs to perform a computation on remote computing resources. For example, a user may need to perform a number-crunching job too heavy for his own desktop computer. Another example, a user may need to analyze a corpus of data already uploaded onto the storage space in the datacenter. A third example, an enterprise may need to host a service in a remote datacenter. As can be appreciated these are just a few possible examples for remote computations than can benefit from the invention.

Common to these situations is the concern about security of the computation and storage. The trustworthiness of the datacenter is a prime factor. As shown herein this invention alleviates the concern about this factor, datacenter trustworthiness, by curbing the administration privileges of the datacenter agents, such that administrators will have no access to the computation and its data. As will be appreciate, the admin access is curbed effectively, while maintaining good scalability and performance, and in some embodiments compatibility to existing standards and code is maintained, too. Using this invention, datacenters can enable customer workloads with assured confidentiality and integrity, independent of the human factor (i.e. independent of the trustworthiness of the admin staff), and with minimal performance impact.

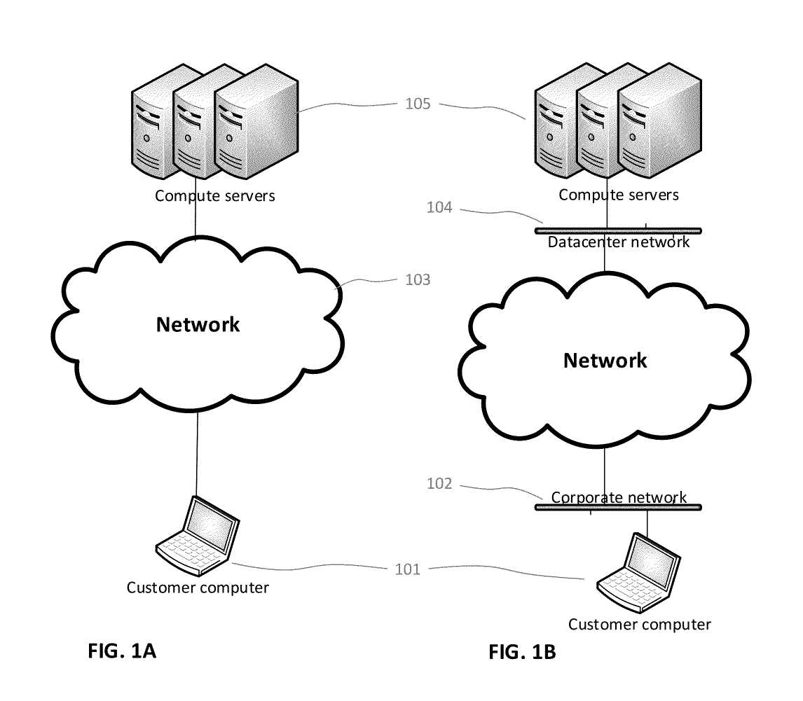

FIG. 1—Example Network Configurations

FIGS. 1A and 1B show sample network configurations in which the invention can be used.

FIG. 1A depicts a relatively simple network configuration. The user has a client computing device 101, illustrated by a notebook labeled “Customer computer”. As can be appreciated, the user computing device may be any networking capable device allowing interaction with remote nodes. Examples include a desktop PC, a tablet computer or a smartphone. The terms client computing device and customer computer or used interchangeably herein.

The remote computing resources 105 are illustrated by a few servers labeled “compute-servers”. The remote computing resources may be any computing device that implements the server side of the invention (described hereinafter). A typical example of such computing device may be servers in datacenters and cloud facilities. Another example is a unique computer deployed remotely, e.g. in a remote research facility, the unique computer has special capabilities required for the computation. Yet another example is a smartphone hosting an app used by a remote user, who can trust the result thanks to this invention ensuring that the owner of the smartphone cannot interfere with the app. The terms compute-server(s) and computing resource(s) are used interchangeably herein. Typically, they are located remotely from the customer computer.

Machine Virtualization is commonly used in datacenters, cloud computing centers and other hosting environments. The invention can interoperate seamlessly with Virtual Machines (VMs) allowing broad adoption of the invention in hosting environments.

Additionally, in some embodiments the invention makes use of an augmented VM to achieve greater degree of scalability and trustworthiness (see details below).

The invention can work with any number of compute-servers. They may be grouped together in physical proximity, or they may be deployed in different locales. Herein the text uses the phrases computer server (singular) or compute-servers (plural) interchangeably.

The customer computer 101 and compute-server 105 are both connected to a network 103, which is illustrated using a cloud-shaped blob labeled “Network”. As far as the invention is concerned the intermittent connectivity suffices.

The invention can be used across any network that provides intermittent connectivity between the customer computer and compute-server. Examples include corporate network, the internet, or an aggregate of interconnected networks as illustrated in FIG. 1B.

FIG. 1B illustrates an example of interconnected distinct networks. The customer computer 101 is connected to a corporate network 102. The compute-servers 105 are connected to a datacenter network 104. The corporate and datacenter are interconnected via another network 103, e.g. the Internet. As can be appreciated by skilled in the art there are numerous variations on this theme of network and interconnected networks enabling connectivity between remote nodes such as the customer computer and compute-servers.

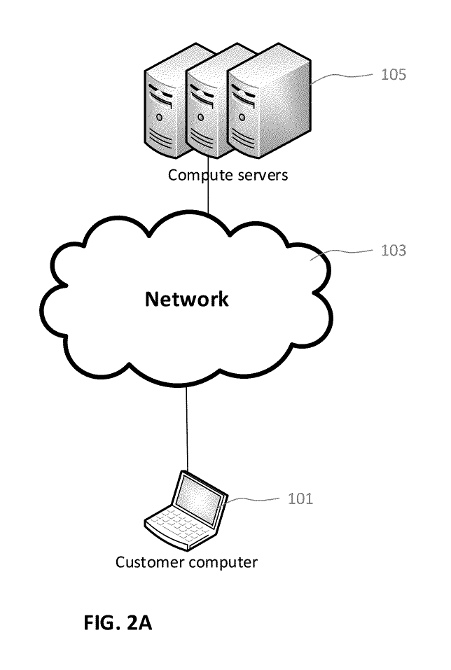

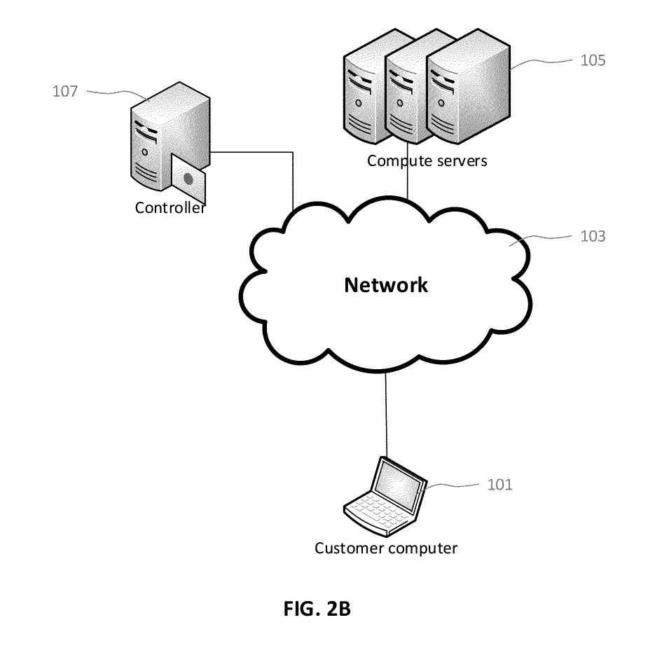

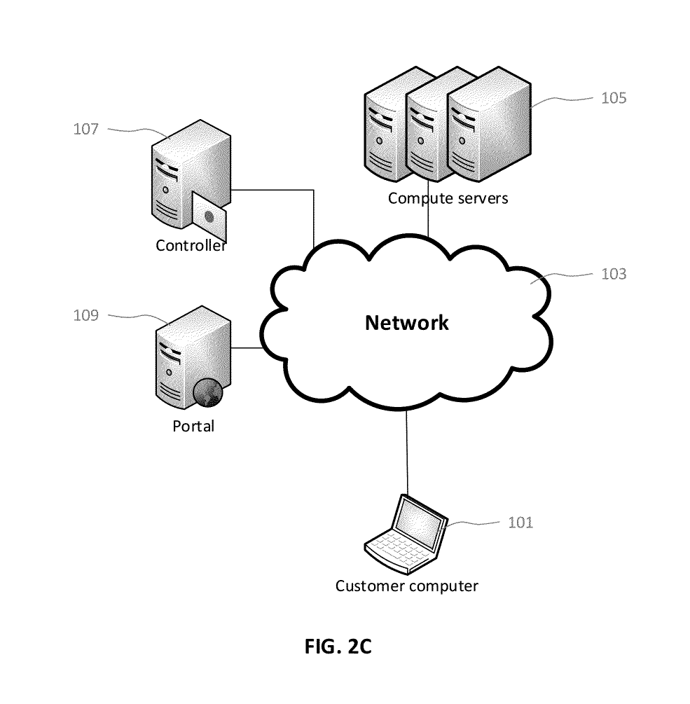

FIG. 2—Example Configurations of the Invention

FIGS. 2A, 2B and 2C illustrate sample configurations of the invention.

FIG. 2A shows a relatively simpler deployment model of the invention. In this embodiment a customer computer 101 vets the trustworthiness of the compute-servers 105 it is about to use. First the client connects to a compute-server via a network 103 interconnecting them. Upon connection establishment, the customer computer asks the compute-server to participate in the trustworthiness vetting protocol. The customer computer challenges the compute-server trustworthiness and determines its trustworthiness based on its responses. If the compute-server is deemed sufficiently trustworthy, then the customer may entrust it with a workload.

In some embodiments trustworthiness is a binary property, i.e. Yes/No determination. In other embodiment trustworthiness measurement may have a discrete number allowing for multiple degrees of trustworthiness. In some other embodiments trustworthiness may be represented using a vector of multiple factors, some of which may be binary, discrete values, or real numbers. In some embodiments the customers may decide whether the trustworthiness of a compute-server suffices for the workload. In other embodiments the customer computer determines whether the compute-server trustworthiness suffices using policies, metadata of the workload and the compute-server trustworthiness information.

Example workloads include (but are not limited to): number crunching jobs, data analysis and processing applications, LOB applications, web services, DNS services, email servers, AN streaming servers, various application stacks such as e-retail and online banking, and mission critical applications such as infrastructure controllers and exchange servers.

FIG. 2B is a superset of FIG. 2A, it introduces a control server 107, dubbed in the illustration “Controller”, which offloads the client from most of the details related to controlling and interacting with compute-servers. The terms control server and controller are used interchangeably herein.

The roles of the controller may include any of:

(1) Vetting the trustworthiness of compute-servers;

(2) Attestation about the trustworthiness of compute-servers;

(3) Matching of workloads to compute-servers;

(4) Enable the interaction or communication between the customers and compute-servers running their workloads.

Trustworthiness Vetting:

When a compute-server becomes available it attempts to register with the control server, which vets its trustworthiness. During the registration process the compute-server is to follow a protocol enabling the controller to vet its trustworthiness. In some embodiments the vetting results in a binary Yes/No outcome. In other embodiments the vetting result may be more granular, where the degree of trustworthiness informs the workload matching.

Attestation:

The controller maintaining a database of trustworthiness assessments has invaluable information useful for the matching of workloads to compute-servers satisfying their trust needs. In some embodiments the controller can publish the trustworthiness database and allow customers to choose the servers they deem best fit for their workloads.

The trustworthiness data may be produced by the controller vetting of the compute-servers (as explained above), or it may be imported from other sources deemed trustworthy enough to rely on for such data.

Workload Matching:

In this role the controller allocates compute-servers to pending workloads. The compute-server trustworthiness is a major consideration. Other parameters may include the workload resource requirements, whether and how much resources where paid for, and regulatory requirements such as location and physical security of the compute-server.

In some embodiments the controller decouples the customer computer and compute-server, such that the client entrust the matching to the controller and has no direct interaction with the compute-server. In other embodiments the controller can consult with the client whether the compute-server is sufficiently trustworthy. In some other embodiments the controller can call in the client to make its own vetting by taking part in the challenger side of the trustworthiness vetting protocol. (See explanation of the protocol below).

Enabling Customer-Server Interaction:

Often customers need access to the compute-server running their workload. The controller matching workloads to server maintains the state information needed to allow communications between customers and their workload while running on the compute-server. In some embodiments the controller acts as a proxy bridging the communication. In other embodiments the controller provides address information enabling the customer computer and compute-server running the workload to communicate directly. The interaction between the customer and compute-server is often contingent on the customer having the authority to access the workload, its computation or data. In some embodiments the controller may be assuming a pivotal role mediating the customer access to the compute-server: ensuring the customer identity and authorization, and ensuring it is accessing the correct compute-server. In other embodiments the controller offloads the authentication and authorization to the customer and compute-server by providing them the relevant information, such that they can mutually authenticate each other and ensure authorized access. As can be appreciated by skilled in the art the various roles of a controller may be implemented as distinct programs that interact with each other. They may be deployed on a single or multiple server computers. Further, in practice, the controller may actually provide only a subset of the functions described herein.

FIG. 2C illustrates an example embodiment that enables publishing trustworthy computing services based on the invention in order to offer them to customers. Whether customers are charged money for the service is immaterial to the invention itself. FIG. 2C is a superset of FIG. 2B, it introduces a portal server 109 which serves as the interface point with customers. Its role is to publish the available trustworthy computing services generally available, and to allow customers to order (and in some implementations to bid on and pay for) the trustworthy computing resources they need. In some embodiments, the portal may allow a customer to submit the workload to be hosted on such compute-servers deemed sufficiently trustworthy.

The workload may include code, data, and metadata. The metadata may include secret key material used to encrypt/decrypt the code and data, and trust policies constraining the set of acceptable compute-servers for the workload. For example, in some embodiments the trust policy can set minimum acceptable compute-server trustworthiness acceptable for the workload. Another trust policy may pertain to the minimum physical security protecting the target compute-servers. Geographic location or the legal framework in the jurisdiction of the compute-server may be relevant to the trust policy as well. As can be appreciated by skilled in the art these trust policies are just examples illustrating the spirit of the invention.

In some embodiments the customer may digitally sign the workload and/or each of its components (code, data, and metadata). In other embodiments such digital signature(s) is required. The controller can use the digital signature to validate the authenticity of the workload before handing it to a matched compute-server.

The controller acts on the customer behalf ensuring his workload is entrusted to a trustworthy compute-server. Therefore, it is advisable that the controller itself is running in trustworthy environment. In some embodiments the controller is secured by the datacenter using traditional security measures unrelated to the invention. In some other embodiments, the controller is hosted on a trustworthy compute-server, very much like those the controller is managing, except that the server hosting the controller was vetted by some other party. The other party may be another controller, or the customer computer itself vetting the controller and its host prior to trusting them. In the latter case the controller and the customer computer execute the trust-vetting-protocol, albeit the controller follows the compute-server role and the customer computer follows the challenger role.

Transport and Communication Security:

The invention defines a few parties including customer computer, compute-servers, controller and portal. The controller may be broken down to constituent services implementing its various roles. In some embodiments the communications between all these parties take place over secure channels like Transport Layer Security (TLS) or Secure Socket Layer (SSL), while in other embodiments regular non-confidential transport suffices.

In some embodiments a hybrid approach may be adequate. In these embodiments some of the communication channels are secured, e.g. using TLS/SSL, while other are on the clear. For instance, the communication between the customer computer and the other parties takes place over TLS/SSL to ensure authenticity and confidentiality over large networks like the Internet. The communication between the portal and controller (or it constituents) may take place on the clear. The communication between the compute-server and the controller may be over a secure channel or not depending on the security parameters of the networking infrastructure they are using.

As explained above the controller or customer computer vets the trustworthiness of the compute-server. In the vetting protocol the controller or customer computer act the challenger role challenging the compute-server to prove it is trustworthy. The phrase ‘challenging party’ refers to the controller and/or customer computer in the context of the vetting protocol. The invention is often described as there is a controller server (illustrated in FIGS. 2B and 2C), but in simpler configurations like those illustrated in FIG. 2A there is no controller and its roles are assumed by the customer computer.

As explained above in deployment configurations including a controller component either the customer computer, or the controller, or both may act the challenging role of the vetting process.

In some other embodiments, the controller may maintain a corpus of compute-servers with their vetted trustworthiness to be used upon customers submitting workloads. The workloads may manifest or imply their trustworthy requirements, or the customer may still re-challenge the compute-server suggested by the controller (based on its on-demand vetting, or corpus of pre-vetted compute-servers).

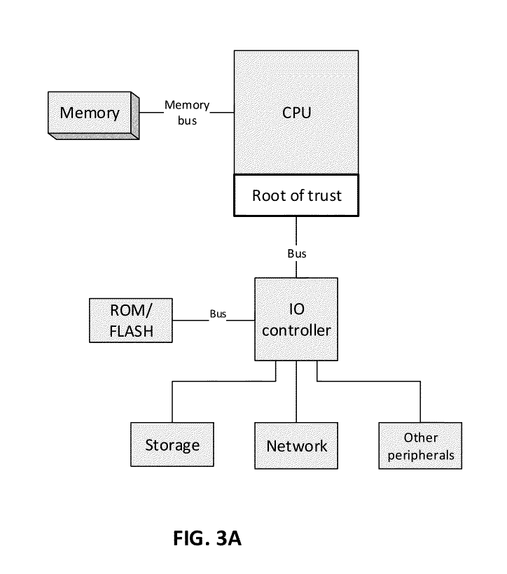

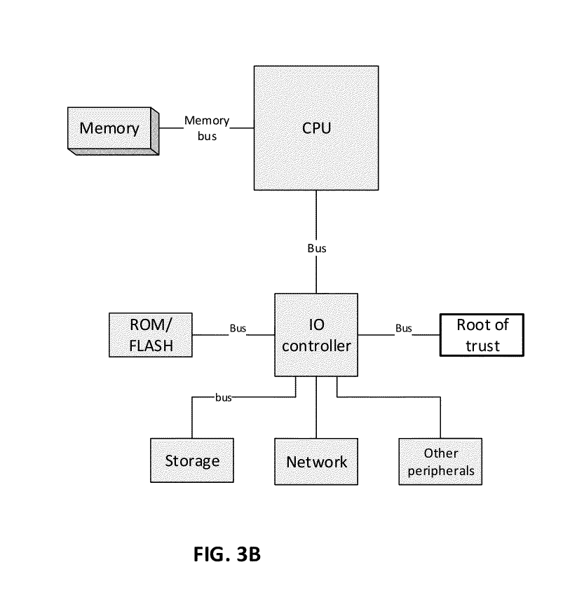

FIG. 3—Example Compute-Server Block Diagrams

FIG. 3 shows example block diagrams of the compute-servers.

Acronyms and terms used herein:
CPU—Central Processing Unit
IO—Input/Output
IOMMU—Input/Output Memory Management Unit
HDD—Hard Disk Drive
SSD—Solid State Drive
RAM—Random Address Memory, often used interchangeably with “memory”
ROM—Read Only Memory
Flash memory—refers to non-volatile storage medium that can be electrically erased and rewritten
BIOS—Basic Input/Output System
USB—Universal Serial Bus
e-SATA—External Serial Advanced Technology Attachment
NAS—Network Attached Storage
SAN—Storage Area Network
WiFi is acronym of Wireless Fidelity. It means wireless local area network.

Though, sometimes it is used more generally to refer to any sort of wireless communication infrastructure
WAN—Wide Area Network

As can be appreciated by skilled in the art these are rather minimalist diagrams focusing on the compute-server components relevant to the invention. The minimalist illustrations are intended to convey the spirit of the invention, and should not be interpreted as limiting its scope.

A compute-server has multiple components relevant to the invention. It has a CPU or multiple CPUs, the CPUs may have a single or multiple cores. The CPUs may have IOMMU (not illustrated) which enables blocking unauthorized direct access to the computer memory (RAM) by other devices on the computer busses, e.g. protecting against a HDD gone rouge.

The compute-server has memory (RAM) connected to the CPU via a bus. In some computers the memory is connected to the CPU directly, in other computers the memory is connected to the CPU via a memory controller (not illustrated).

The compute-server has an IO controller connected to the CPU via a bus or through an intermediary controller sometimes called “North Bridge” (not illustrated).

The computer has a networking interface which is wired to the IO controller, and can be connected to a network. The network interface may be wired—e.g. Ethernet, or wireless—e.g. WiFi or WAN. Other network implementations and protocols are applicable as well.

The compute-server has mass storage capability, labeled “Storage”. Storage may be a local component, e.g. HDD and/or SSD, which is connected to the IO controller via a bus. Storage may be an external device, e.g. external HDD connected via USB or e-SATA, dubbed “Other peripherals” in the FIGS. 3A and 3B. Other storage solutions may be interfaced via the network—and are known as NAS or SAN solutions.

Quite often the compute-server has non-volatile memory, e.g. ROM or FLASH. The non-volatile memory is often used to store the initial boot sequence and BIOS. In other implementations the initial boot sequence is etched into the CPU itself or the memory controller (not illustrated), or it is being loaded from some other source.

The compute-server has a component or capability dubbed “root of trust” (RtTr). FIG. 3A illustrates embodiments in which the RtTr is an integral part of the CPU, or is attached to the CPU. FIG. 3B illustrates embodiments in which the RtTr is connected via a bus to the IO controller. In some implementations the RtTr may be as simple as a smart card installed in a smart card reader plugged to the IO controller as a peripheral device. In some other embodiments the RtTr is a capability implemented using other components.

Root of Trust (RtTr) Defined:

A major property of the RtTr is that it has an established trust relationship with some other party and it can use it to credibly attest certain facts, such that the other party can trust such attestations. In the context of this invention the compute-servers need to have a RtTr which is acceptable by the challenging party—the controller or customer computer. Other requirements are that the RtTr is capable of computing the said attestations without dependency on untrusted parties or components, and is able to communicate the resulted attestation through its interfaces in response to a request.

In some embodiments an off-the-shelve root of trust may be used. Examples of such RtTr include Trusted Platform Module (TPM) combined with a trusted booting BIOS which assesses the integrity of the next module in the boot sequence—the boot loader, smart cards or the chips used thereof. In some other embodiments a custom RtTr can be installed on each compute-server. A notable example is an augmented BIOS which self protects such that only provably genuine new BIOS revisions are allowed to override the exiting one.

A common technique used by the RtTr to ensure the authenticity of attestations is time stamping and digitally signing them. The digital signature follows commonly used techniques and practices like public key and/or secret key cryptography. As can be appreciated by skilled in the art there may be multiple ways to ensure the authenticity of messages, some of which may utilize cryptography while other may use other mechanisms.

In some embodiments the RtTr has a certificate being trusted by the challenging party—the controller or customer computer. The certificate itself may be trusted through a certificate chain leading to a trusted root of trust acceptable to both the challenging and challenged parties (i.e. the controller and/or customer computer and the compute-server).

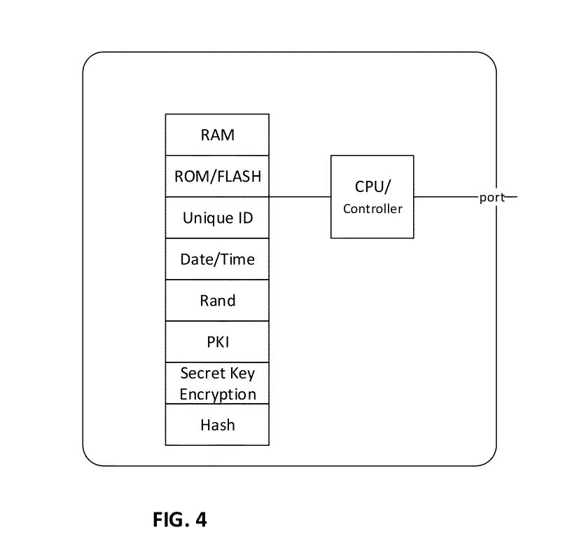

FIG. 4—Isolated Computing Environment (ICE)

An Isolated Computing Environment (ICE) is a computing environment isolated from other parties, such that the code running in the ICE is protected from adversaries out of the ICE.

FIG. 4 illustrates components and capabilities of an example ICE. Essentially an ICE is a self-contained computation device. Trusted Platform Module (TPM) and smart cards are examples of an ICE. ICEs, though, are not limited to such relatively small devices. As will be appreciated, an off the shelf compute-server may be configured to qualify as an ICE.

The example ICE in FIG. 4 includes a controller or CPU, which interacts with the external world through a port or some other interface (not illustrated). An ICE may be designed such that the CPU has full control on the input and output that passes through the port, allowing the CPU to scrutinize the traffic that goes through the port to intercept potential attacks on the ICE.

The ICE controller has access to memory in the ICE—marked “RAM”, and to nonvolatile memory—marked “ROM/FLASH”.

The ICE may have a Unique ID (identity). It may be etched into the ICE circuit or stored in its non-volatile memory. The unique ID may implemented by a serial number, a nonce, a string, or some other scheme.

The ICE may have a “Date/Time” capability which keeps tracks on date/time. In some embodiments the ICE has a runtime counter used to keep track on time since waking up, which is initialized upon reset and or wakeup from standby.

The ICE may have a random number generator labeled “Rand” in FIG. 4. The ICE may have a public key encryption capability and secret (a.k.a. symmetric) key encryption/decryption capability. These ICE components are dubbed “Public Key Infrastructure (PKI)” and “Secret Key Encryption” respectively. The ICE may have a cryptographic hash capability—marked “Hash” in FIG. 4.

In some embodiments any of date/time tracking, random number generation, PKI, secret key encryption and cryptographic hash may be implemented using hardware, microcode or software modules stored in the ICE ROM/FLASH. Further, any of these capabilities may support multiple algorithms, e.g. multiple hashing schemes.

As can be appreciated by the skilled in the art there may be many implementations of the ICE concept. For example, a regular desktop computer that is interfaced via a firewall may qualify as an ICE. Similarly, an off the shelf server computer commonly used in cloud computing and hosting datacenters may qualify as an ICE. It is advisable to configure its BIOS and boot sequence following security best practices. This basic ICE implementation may suffice as a foundation for this invention.

Yet another ICE example, also based on off the self-components, is a compute-server configured to boot a hardened mini-BIOS which temporarily locks down the PC, deferring the enablement of the various peripherals to allow a highly regulated and secure boot sequence. Such mini-BIOS may utilize a TPM chip if present or substitute its relevant functions with code and non-volatile memory. The mini-BIOS, unlike typical BIOS implementations, delays enumeration and enabling of various computer peripherals (unnecessary to the boot sequence and vetting), and gives precedence to a secure boot sequence and vetting process as the challenged party.

As can be understood by skilled in the art these examples as well as other embodiments differ by various characteristics including cost and availability. Each may be best suited for different situations.

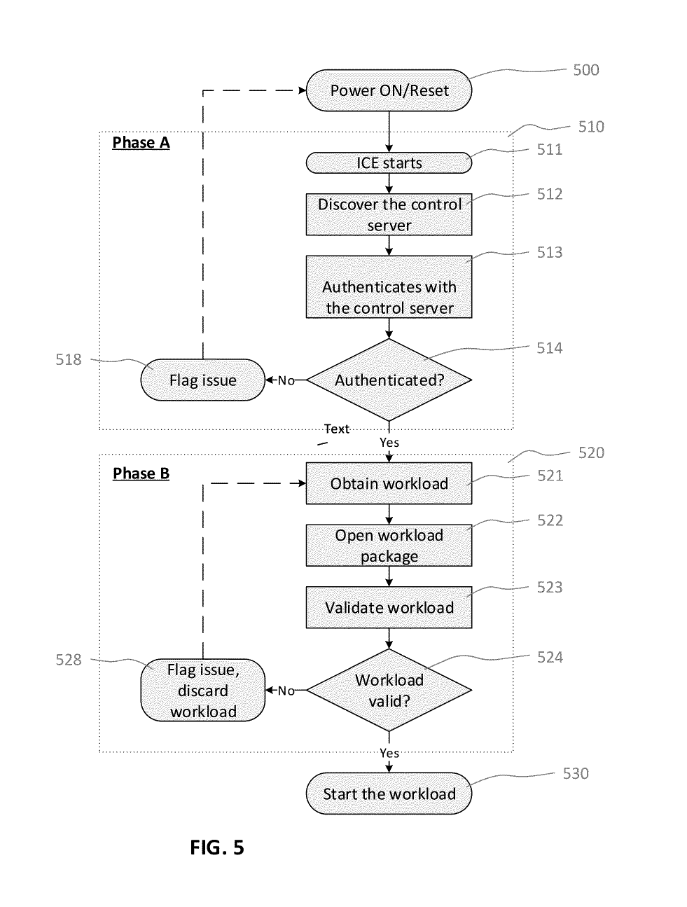

FIG. 5—Compute-Server Boot Sequence and Vetting

FIG. 5 illustrated a flowchart of an example compute-server boot sequence and vetting from the compute-server perspective.

As can be appreciated there may be multiple boot sequences enabling this invention. The illustrations and specifications describe the spirit of the invention and should not be interpreted as limiting it.

FIG. 5 shows a sample boot sequence of the compute-server. It starts with Power ON or Reset 500. Upon reset or power-ON 500 the compute-server starts its ICE 511. As explained above an ICE may be as simple as the built BIOS, a hardened mini-BIOS, a custom ICE implementation, or some other embodiment that meets the ICE requirements.

The compute-server ICE starting upon reset or power-ON is configured with boot functionality comprised of two phases. In phase A 510 it authenticates with the controller. In step B 520 it obtains a workload, and starts it in step 530.

Phase A starts at step 511 which includes initialization of the ICE.

In step 512 the ICE discovers the control server 107 (see FIG. 2B). In some embodiments the discovery of the control server is as simple as a hard coded variable or configuration information stored in its non-volatile memory. In some embodiments the discovery uses standard network protocols such as Domain Name Service (DNS) lookup, Service Discovery Protocol (SDP), and others.

After discovery the ICE connects with the controller (not illustrated). In some embodiments the connection is done using a secure channel, e.g. TLS/SSL, to ensure confidentiality and integrity of the communications.

In some embodiments the ICE authenticates the controller 107 to ensure it is the right controller. As can be appreciated by skilled in the art there are multiple authentication protocols that may be used here. Some examples include utilizing the TLS/SSL built-in authentication scheme (similarly to how browsers authenticate https web sites), X509 certificate based authentication, and public key and/or secret key based authentication.

If the ICE is not satisfied with controller authentication, then it stops trusting the controller and flags the issue. Various correction actions may be attempted here such as retrying from step 500 (which my work if the failure was a temporary situation), or triggering a support ticket.

In step 513 the ICE authenticates with the controller. As explained above the controller vets the trustworthiness of the compute-server. This is done using an authentication protocol in which the compute-server attempts to prove its authenticity and trustworthiness. In some embodiments the ICE fingerprints its own code and sends it to the compute-server for evaluation against a library of trusted fingerprints. The fingerprinting is done by computing a hash value of the ICE code and constants. In some embodiments secret key and/or public key cryptography is being used. In some embodiments the vetting process authenticating the compute-server requires the ICE to combine authentication of its identity with fingerprinting of its code, digitally signed with a time stamp or a nonce produced by the controller. In some implementations the ICE uses off-the-shelf components like TPM to assist in the authentication and vetting process. In these implementations the ICE may utilize TPM's internal certificates for its identity and/or authentication. Such implementations may use TPM's registers to track the boot sequence fingerprinting (hash values). Additionally, such implementations may use TPM to attest to or digitally sign the information the ICE sends back to the controller, e.g. hashing of the boot sequence code. In some cases such implementations may base the ICE itself on the Trust Platform root of trust BIOS. As can be appreciated the invention may use any of multiple authentication protocols and vetting schemes here.

In step 514 the ICE checks whether its authentication and vetting with the controller was successful. If it was not successful then it follows to step 518, in which it flags the issue and may trigger corrective actions. If the controller vetting of the compute-server was positive then the ICE follows to Phase B 520.

The controller keeps track on the compute-server 105 vetting process. Should the compute server 105 fail the vetting of its trustworthiness (by the controller 107 or customer computer 101), then the controller 107 deems the compute-server 105 as untrustworthy. It denies it any further cooperation. Also, it may flag the issue and may take corrective action like filing a support ticket. As discussed above trustworthiness may be a discrete value or a vector. The controller being the vetting party maintains this state information and uses it subsequently to match the compute server with an appropriate workload.

Phase B 520 starts with step 521, in which the ICE obtains the workload. In some embodiments the ICE asks the controller to provide or point the workload (which it does only if the ICE passed the vetting in step 513 successfully). This allows the controller to match pending workloads to vetted compute-servers. As will be appreciated this also allows the controller to direct the boot sequence. In some other embodiments the ICE obtains the workload from a default location such its own storage or network storage.

In step 522 the ICE opens the workload. In some embodiments opening the workload may entail decrypting it. In some embodiments the key material needed to decrypt the workload package is attached to the package. In other embodiments the key material should be obtained from the controller, which sends the keys if it indeed trusts the compute-server. In some embodiments this back-and-forth requires the ICE to re-authenticate with the controller.

In step 523 the ICE may validate the workload. In some embodiments validation is as simple as checking that it is not corrupted. In other embodiments the validation checks the package for integrity and/or authenticity. This may be done by evaluating the package digital signature. In some embodiments the ICE takes a fingerprint of the package by hashing it and sends the hash value to the controller for confirmation.

In step 524 the ICE acts on the validation outcome. If the workload is deemed invalid, it follows to step 528 which flags the issue, discards the workload, and follows back to step 521. If the workload is deemed valid, then the ICE follows to step 530.

In step 530 the ICE simply starts the new workload, which was validated in the 523. The workload may be any program and may include data. For example, a self-contained program, a comprehensive stack comprising a service running on standard OS like Windows or Linux, or any other package comprised of code, data and metadata.

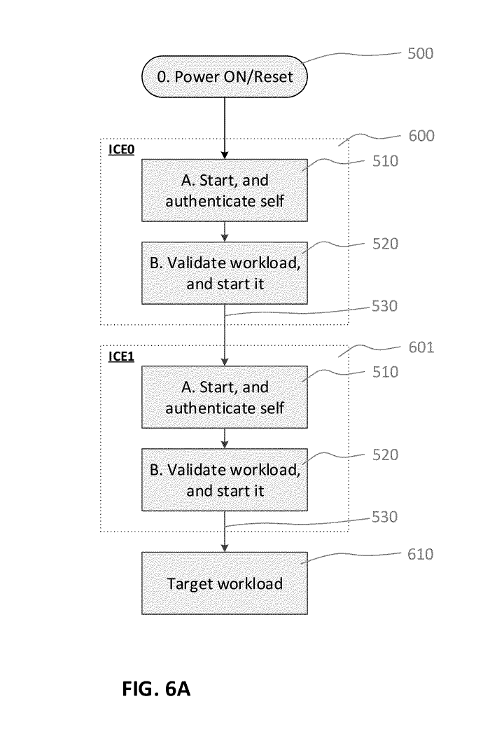

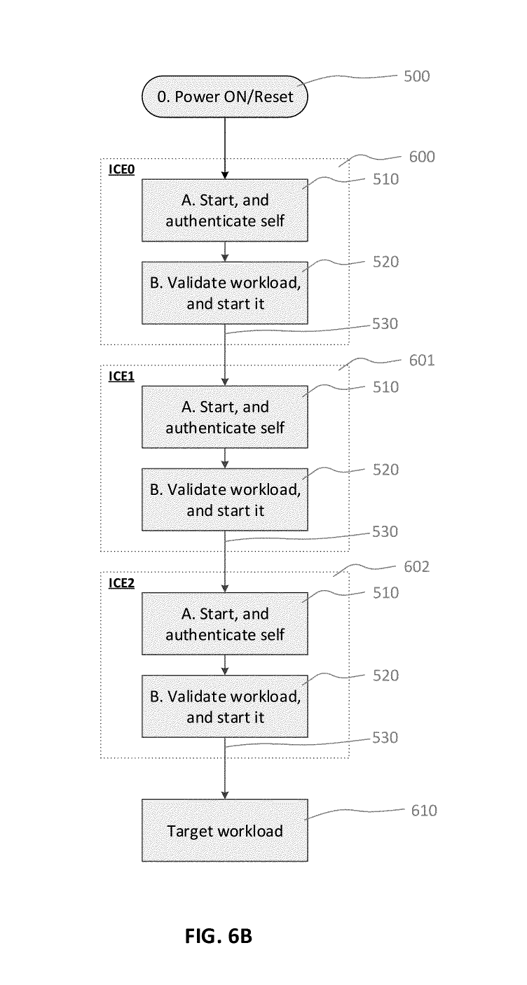

FIG. 6—Multi Staged Boot Sequence:

FIGS. 6A and 6B illustrate a two and three staged boot sequence and vetting of the compute-server side.

In some embodiments the boot sequence may be comprised of a chain of ICEs, each of them may be configured with the A-B boot-and-vetting sequence described above. In this case the workload obtained in step 521 may be another ICE, which is also configured with the boot-and-vetting capability described above. This enables the controller 107 to fine tune the configuration and usage of the compute-server. For instance it allows the controller to load the compute-server with a Virtual Machine Monitor (VMM), packed as a workload, on which multiple other workloads can be loaded and executed after being vetted by the controller to ensure no rouge or adversary code is inserted into the compute-server.

FIG. 6A illustrates an example embodiment which is comprised of a chain of two ICEs, designated as ICE0 600 and ICE1 601. FIG. 6B adds ICE2 602. In multi-ICE embodiments, each ICE considers the next one as a workload. That “next” workload just happens to be an ICE, too. The last workload being loaded and started is the target workload 610, i.e. a workload that was submitted by a customer for execution on a trustworthy compute-server. It is not required from the target workload to be an ICE, but it may be an ICE when is needed (e.g. when performing highly sensitive computations).

As can be appreciated by skilled in the art there may be multiple ICE embodiments. Some existing components may qualify as an ICE even though they fulfill other functions. In some embodiments an existing component may be modified to qualify as an ICE, while maintaining some of its functions. In some embodiments a computer BIOS may qualify as ICE. In other embodiments a booting ICE may substitute traditional BIOS and perform some of its most essential functions. In other embodiments a computer BIOS may be modified to qualify as an ICE while maintaining some of its BIOS functions. As can be appreciated by skilled in the art similar thought process can be applied to other established functions and components such as Virtual Machines Monitors (VMMs), Virtual Machines (VMs) and Operating Systems (OSes).

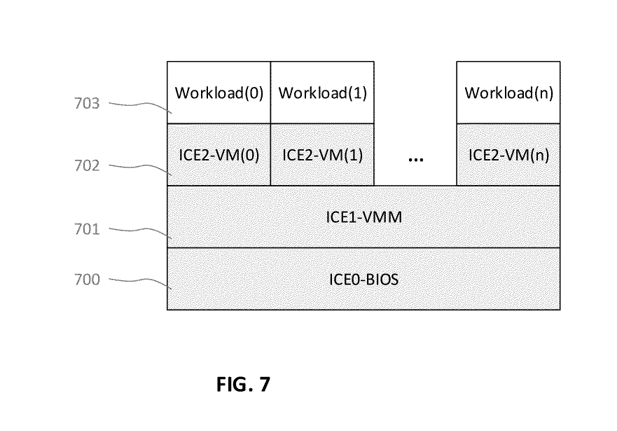

FIG. 7—a Vetted BIOS-VMM-VM-Workload Boot Chain:

In FIG. 6B and FIG. 7 show an example of a triple ICE boot sequence is illustrated. Each of the ICEs treats the next one as yet another workload, which happens to be a booting ICE too, i.e. an ICE with boot functionality.

FIG. 7 shows an example of scaling the multi-ICE boot sequence to enable trustworthy virtual machine based hosting, such that the workloads running on the compute-server(s) are protected from first party attacks.

ICE0 implements BIOS functions. Therefore FIG. 7 designates it as ICE0-BIOS 700.

ICE1 implements VMM functions. Therefore, it is designated as ICE1-VMM 701.

ICE2 implements the logic of a VM partition containing the respective workload. It is designated as ICE2-VM(x) 702 where x is the VM partition index.

ICE2-VM(x) 703 starts the corresponding target workload(x).

As can be appreciated the layered model illustrated in FIG. 7 is just an example and should not be interpreted to limit the scope of the invention.

Properties of ICED-BIOS, ICE1-VMM, ICE2-VM:

The ICEs in a boot chain were validated using the vetting protocol between the previous lower level ICE and the controller, with the exception of ICE0. ICE0 is trusted a-priori (e.g. as its code is etched into the CPU or FLAH/ROM), or self-vetted as explained above, or vetted by a RtTr installed on the compute-server—like TPM.

ICE0-BIOS may also provide BIOS functions essential to booting a computer. Yet, it must satisfy the ICE criteria ensuring isolation from adversaries. The degree of isolation may vary across various implementation and deployments. For instance, an adversarial deployment environment may require a hardened and strict isolation. A benign and trusting environment may be satisfied with a “soft” ICE which is based on configuring standard off the shelf computing components (e.g. a Windows or Linux based server without any special changes or treatment).

Similarly, ICE1-VMM may provide VMM functions while isolating itself and the workload it starts from external adversaries. In some embodiments, unlike typical VMMs, ICE1-VMM is not very interactive and responsive to external requests. In such embodiments ICE1-VMM may not allow the datacenter staff to configure it or the hosted VMs as they see fit. The strict approach is that no such capabilities are enabled. As can be appreciated by skilled in the art this simple strict policy can be relaxed. For example: allowing datacenter staff to instruct the ICE1-VMM to shutdown its hosted partitions, performing a backup of the VMM partitions, or directing the VMM to install a patch. In stricter embodiment, a byproduct of the ICE criteria is that an ICE-VMM encrypts all the data it stores out of the compute-server memory (RAM and storage) so adversaries won't be able to exploit it.

Often the key material is an integral part of the VMM workload initiated by ICE0-BIOS. In other words, this architecture enables the controller to deploy a VMM of its choosing (or the customer choosing). In this case the VMM may be programmed to apply such strict security policy to satisfy the a high-bar ICE qualification, including encryption of its storage.

Similarly, ICE2-VM may provide VM functions while isolating its workload from external adversaries. The security policy follows the same thought process as ICE1-VMM. The VM may encrypt any data stored out of the VM, including its Virtual Hard Disk (VHD) and memory (RAM) backed up onto the host storage. A simple approach may dictate that no external party has authorization to modify the VM configuration or access its state. A more relaxed policy may be considered so long it does not jeopardizes the ICE properties of the VM (as deemed satisfactory given the customer needs and setting of the deployment). This may allow the datacenter staff to perform the most basic maintenance and monitoring of the hosted workloads. For example the datacenter staff may backup the VM (including its hosted workload), monitor its basic status, shut it down and restart it, change the amount of resources available to the VM and its hosted workload, and possibly direct the application of software updates to the VM or its workload. Similarly to the ICE1-VMM, an ICE2-VM may encrypt any data it stores out of the compute-server memory. The encryption capability may be a property of the ICE2-VM, and the key material may be attached to it in the workload encompassing it (validated and started by the previous lower level ICE).

A practical and scaling way to use the invention is for the controller start a new target workload in its own fresh VM. A corollary is that the VMM has to be configured to always have standing request to the controller to start yet another workload, which the controller uses to vet the VMM. If the VMM passes the vetting, which it expectedly always does, the controller submits to the compute-server a fresh VM and target workload.

What is claimed is:

1. A system enabling trustworthy hosting of workloads on remote compute-server, ensuring that first party agents have no access to the workload computation and data regardless of the agents' privileges; where first party agents includes the hosting facility administrators.

2. The system in claim 1, where the agents of the first party cannot read the code and data of the hosted workload.

3. The system in claim 1, where the agents of the first party cannot tamper with the code and data of the hosted workload.

4. The system of claim 1, where the compute-servers trustworthiness is a tuple of values describing various aspects such as its authenticity, degree of hardening, degree of physical security, and legal framework governing the physical hardware and its location.

5. The system of claim 4, where there is a device, called controller, keeping track on a corpus of compute-servers, their trustworthiness, and availability.

6. The system of claim 5, where the controller receives requests to run workloads; each workload includes code, data, and metadata describing its trustworthiness requirements.

7. The system of claim 6, where the controller matches between workload and compute servers such that a workload always runs of a compute-server satisfying its trustworthiness requirements.

8. A device, called compute-server, which follows a regulated boot and vetting protocol; the protocol enabling the compute-server to pass a trustworthiness vetting with a control server or customer computer

9. The compute-server in claim 8, where it allows the vetting counterparty to direct what workload it is to run.

10. The compute-server in claim 9, where the workload may be a Virtual Machine (VM).

11. The compute-server and VM in claim 10, where the VM implements the vetted party side of the vetting protocol, and receives and validates requests to run a target workload.

12. The compute-server in claim 10, where the VM is hardened to limit the administrator access to the workload by allowing any of: starting and stopping the VM, backing up the VM memory and Virtual Hard Drive (VHD).

13. The compute-server in claim 9, where workload is a VMM capable of running multiple VMs, each running a target workload.

14. The compute-server in claim 13, where each new target workload is loaded onto a fresh VM.

15. A method enabling trustworthy hosting, protecting the hosted workload from the hosting party reading or tampering with it.

16. The method in claim 15, where the method enables a controller server to offload the customer initiating the workload request.

17. The method in claim 15, where the method enables a controller server to maintain a corpus of trustworthy compute servers.

18. The method in claim 17, where the trustworthiness is a tuple of values describing various aspects such as its authenticity, degree of hardening, degree of physical security, and legal framework governing the physical hardware and its location.

19. The system in claim 1, where the network infrastructure is intermittent.

20. The device in claim 8, where the network infrastructure is intermittent.
